(19) United States
(12) Patent Application Publication
(10) Pub. No.: US 2025/0136446 A1
(43) Pub. Date: May 1, 2025

(54) CARBON MATERIAL

(71) Applicants: ELEMENT SIX GMBH, Burghaun (DE); ELEMENT SIX (UK) LIMITED, Didcot, Oxfordshire (GB)

(72) Inventors: Igor Yurievich Konyashin, Burghaun (DE); Nicola Louise Palmer, Didcot (GB); Pierre-Olivier Francois Marc Colard, Didcot (GB); Daniel James Twitchen, Didcot (GB)

(73) Assignees: ELEMENT SIX GMBH, Burghaun (DE); ELEMENT SIX (UK) LIMITED, Didcot, Oxfordshire (GB)

(21) Appl. No.: 18/682,998

(22) PCT Filed: May 20, 2022
(86) PCT No.: PCT/EP2022/063716

§ 371 Date: Feb. 12, 2024

(30) Foreign Application Priority Data
Aug. 19, 2021 (GB) 2111893.0

(51) Int. Cl. C01B 32/05

(52) U.S. Cl. CPC C01B 32/05; C01P 2002/30; C01P 2002/82; C01P 2006/40

(57) ABSTRACT

There is disclosed a carbon material having a face-centered cubic crystal lattice characterized by a space group Fm-3m, and containing at least 99.9 atomic % carbon, wherein the mean grain size of the carbon material is greater than 0.5 μm.

### FIELD OF THE INVENTION

This disclosure relates to the field of carbon material, in particular a form of metametallic carbon material, and methods of making the material.

### BACKGROUND

Carbon is potentially a useful material for electronic applications when considering the outstanding properties of diamond, e.g. its exceptionally high thermal conductivity and wide bandgap. This makes it possible to employ diamond wafers as substrates for microelectronic devices allowing ‘carbon electronics’ to be produced (Balmer et al., Unlocking diamond's potential as an electronic material. Phil. Trans. R. Soc. A, 366(2008)251-265).

However, a big challenge with respect to creating ‘carbon electronics’ has been the absence of a carbon allotrope and carbon materials having electrically conductive or semi-conductive properties, which remain constant and independent of the crystal lattice orientation and environment. It is well known that graphite is characterized by a relatively high electrical conductivity, but only in the direction parallel to the planes of the graphene sheets that form its crystal lattice; in the perpendicular direction its electrical conductivity is low. The possibility of employing 2D-systems, such as carbon nanotubes or graphene for large-scale fabrication of microelectronic devices is still a big challenge. One of the reasons for that is the strong dependence of the electronic properties of graphene on the supporting substrate. Another reason is related to the fact that charge transport in graphene is strongly affected by adsorption of contaminants, such as water and oxygen molecules, leading to inconsistent electronic properties.

There are also other reasons making the production of ‘carbon electronics’ very difficult, such as potential high production costs, problems with scalability, lack of shallow donors/acceptors, sophistication of process technologies.

As for a metallic carbon allotrope, several theoretical studies show that carbon might have a metallic character, but only at extremely high pressures, which cannot be achieved by use of presently existing experimental techniques (Correa et al. (January 2006). “Carbon under extreme conditions: phase boundaries and electronic properties from first-principles theory”. Proceedings of the National Academy of Sciences of the United States of America. 103 (5): 1204-8. Bibcode:2006PNAS.103.1204C. doi:10.1073/pnas.0510489103. ISSN 0027-8424. PMC 1345714. PMID 16432191). Therefore, such a metallic carbon allotrope has not yet been synthesized and the possibility of obtaining it at extremely high pressures is not proven in practice.

A conventional method of obtaining diamond in the form of conductive or semi-conductive materials is doping carbon with boron. Much activity has been focused on unipolar devices based on boron-doped CVD diamond. However, boron acceptors are only weakly activated at room temperature due to the high ionization energy (0.36 eV), so that the boron concentration in diamond must be high to achieve its electrical conductivity, which leads to undesirable effects (Nebel C. E., Stutzmann, Transport properties of diamond: carrier mobility and resistivity. In “Properties, growth and applications of diamond”, M. H. Nazare and A. J. Neves (Eds.). IEE Emis Datareviews Series, 2001, UK: Institute of Engineering and Technology, No. 26. p.45). Boron-doped diamond is therefore not presently employed in microelectronic devices.

It would be desirable to obtain a carbon allotrope and material, which is characterized by inherent electrical conductivity and has properties of intrinsic semiconductors (also known an ‘undoped semiconductors’ or ‘i-type semiconductors’). The electrical conductivity of intrinsic semiconductors can be due to crystallographic defects or electron excitation and might vary in a wide range; it can also be a special feature of intrinsic semiconductors consisting of fundamentally new materials, particularly uncommon metastable allotropic modifications of carbon or other chemical elements (Neamen, Donald A. Semiconductor Physics and Devices: Basic Principles (3rd ed.). McGraw-Hill Higher Education. 2003). It is likely that either n-type or p-type semiconductors can be produced on the basis of such a carbon allotrope/material by its doping with insignificant amounts of different chemical elements, thus making it an ideal material for carbon microelectronic devices.

Recently a new metastable carbon allotrope having a face-centered cubic (fcc) crystal lattice was synthesized by different methods including high-pressure high-temperature (HPHT) synthesis, plasma assisted chemical vapour deposition (PACVD), and etching of diamond surfaces in hydrogen plasmas (Konyashin et al., Nanocrystals of face-centered cubic carbon, i-carbon and diamond obtained by direct conversion of graphite at high temperatures and static ultra-high pressures, Diamond and Related Materials, 109(2020)108017, https://doi.org/10.1016/j.diamond.2020.108017; Konyashin et al., A new hard allotropic form of carbon: Dream or reality? International Journal of Refractory Metals and Hard Materials, 24(2006)17-23; Jarkov et al., Electron Microscopy Studies of fcc Carbon Particles, Carbon, 36(1998)595-597). Nevertheless, all the materials on the basis of this carbon allotrope in form of thin films were obtained as nanomaterials with grain sizes of about 50 nm. It is well known that such carbon nanomaterials comprise a great number of grain boundaries, which are usually sp²-hybridized. Indeed, the presence of sp²-hybridized carbon was established in the nano-structured thin films of the new carbon allotrope obtained by PACVD (Konyashin et al. A new hard allotropic form of carbon: Dream or reality? International Journal of Refractory Metals and Hard Materials, 24(2006)17-23). Therefore, the expected contribution of these sp²-hybridized grain boundaries to electronic properties of materials based on this new carbon allotrope can be quite significant resulting in the degradation of their semi-conductive properties and their inconsistency.

### SUMMARY OF THE INVENTION

There is a need to produce carbon materials based on this new carbon allotrope in form of coarse-grain materials with a mean grain size in the μm-range, which will lead to a negligibly low volume fraction of grains boundaries and consequently no or very low contribution of the sp²-hybridized grain boundaries to the electronic properties of these materials.

Not being bound by theoretical estimations of the nature of chemical bonds in the new carbon allotrope, one can expect that the chemical bonds are fundamentally different from those of conventional well-known carbon modifications characterized by sp³-, sp²- and sp¹-types of electron hybridization.

Until recently, a generally accepted viewpoint on this carbon allotrope has been that it is a metallic form of carbon. However, it is characterized by a very uncommon combination of its crystal lattice type and lattice parameter in comparison with typical fcc metals, like Cu or Ni. Therefore, it is unlikely to be a metal. Although the carbon atomic diameter is significantly smaller than that of typical fcc metals, the crystal lattice parameter of the carbon allotrope with the fcc crystal lattice and that of such metals are very similar. For example, the lattice parameters of typical fcc metals, Cu and Ni, are equal to 0.3615 nm and 0.3524 nm at the corresponding atomic radii of 0.145 nm and 0.149 nm. Similar values of the lattice parameter of the carbon allotrope with the fcc crystal lattice (0.354-0.356 nm) take place at a carbon atom radius as low as 0.7 Å. Also, the Herzfeld criterion for metallic conductivity (Herzfeld K. F. On atomic properties which make an element a metal, Phys. Rev., 29(1927)701-705) is not satisfied for this carbon allotrope, so it cannot be a metal.

A hypothesis explaining the nature of the chemical bonds in the carbon allotrope with the face-centered cubic crystal lattice is proposed based on the following considerations. The atomic radius of carbon in the fcc crystal lattice lies in the range between the carbon covalent and van der Waals radii, known as the ‘van der Waals gap’. The van der Waals gap is characterized by the presence of unconventional chemical bonds, such as hydrogen bonding, π-π stacking interactions, halogen bonding, etc.

Generally, when some type of a chemical bond occurs in the solid state, according to molecular orbital theory it is hardly possible to designate it as a single bond between two individual atoms, as the forces attracting atoms and forming the crystal lattice can be of a collective nature. It is therefore suggested that the resulting chemical bonds might be described in terms of gigantic molecular orbitals bonding the entire crystal. Carbon atoms can be characterized by the presence of unhybridized s- and p-electrons in the 2s¹2p³ configuration (Kolotilo, D. M. Theory of the electronic structure of an unsaturated carbon-carbon bond and its change during the high-temperature treatment of organic compounds, Khimiya Tverdogo Topliva, 3(1968)46-54). It is likely that in this case the three electrons of p orbitals (2pₓ, 2p_{y} and 2p_{z}) can form an electron cloud with a spherically or nearly spherically symmetric charge distribution. It is therefore suggested that such electron clouds can interact with each other leading to some electron sharing in the fcc carbon crystal lattice, similar to the non-covalent π-π stacking in organic and inorganic substances described in literature (Kertesz M. Pancake Bonding: An Unusual Pi-Stacking Interaction, Chem. Eur. J. 2019, 25,400-416). It is well known that in the conjugated systems of π-electrons represented by organic aromatic species and graphene sheets, which are characterized by resonance bonding, the formation of connected π orbitals, in general, lowers the overall energy of the systems and increases their stability.

It is therefore proposed that interactions among the electron clouds, which are formed by unhybridized or nearly unhybridized p orbitals of carbon atoms in the state close to the 2s¹2p³ configuration, might lead to overlapping these electron clouds resulting in some electron sharing. If the electron clouds have a spherically or nearly spherically symmetric charge distribution, each electron cloud would overlap with the neighbouring electron clouds forming 12 symmetric regions of such overlapping, thus resulting in the fcc crystal lattice with the coordination number of 12. It is therefore suggested that the carbon allotrope with the face-centered cubic crystal lattice is distinguished from other known carbon modifications by designating it as ‘metametallic carbon’, as this carbon allotrope is not a metal but possesses some features of metals and semiconductors due to the presence of uncommon chemical bonds in its crystal lattice.

In all the published works on the carbon allotrope with the face-centered cubic crystal lattice, or ‘metametallic carbon’, the metametallic carbon was in the form of nanomaterials with grain sizes of below 100 nm. It is well known that such carbon nanomaterials, for example nanodiamonds, are characterized by the presence of numerous grain boundaries comprising mainly sp²-hybridized carbon. Indeed, the nanostructured films of the carbon allotrope with the face-centered cubic lattice, metametallic carbon, having grain sizes of below 100 nm described in literature are characterized by the presence of signals typical for sp²-hybridized carbon in their Raman and electron-energy loss spectra (see e.g., Konyashin et al. A new hard allotropic form of carbon: Dream or reality? International Journal of Refractory Metals and Hard Materials, 24(2006)17-23; Konyashin et al. A New Carbon Modification: ,n-Diamond' or Face-Centered Cubic Carbon? Diamond Relat. Mater., 10(2001) 99-102). It is likely that sp²-hybridized carbon in this case is located just at grain boundaries, which accounts for a significant volume proportion in such nanostructured carbon materials. When taking into consideration special features of the numerous grain boundaries consisting of sp²-hybridized carbon, it appears to be impossible to employ metametallic carbon in form of nanomaterials for fabricating microelectronic devices.

It has now surprisingly been found that if metametallic carbon is obtained in form of coarse-grain films having a mean grain size lying in the μm-range (coarser than 0.5 μm, preferably coarser than 1 μm, most preferably coarse than 2 μm or in the form of single crystalline epitaxially grown films) the contribution of the grain boundaries consisting of sp²-hybridized carbon becomes negligibly small. Spectroscopic studies of metametallic carbon in form of thin films with such a large mean grain size or in the form of single crystals do not indicate the presence of any sp²-hybridized carbon. This is thought to make it possible to employ such thin films of metametallic carbon as components of electronic devices due to its unique electrical conductivity typical only for intrinsic semiconductors (between 0.01 S/m and 100 S/m, preferably between 0.05 S/m and 10 S/m).

According to a first aspect, there is provided a carbon material having a face-centered cubic crystal lattice characterized by a space group Fm-3m and containing at least 99.9 atomic % carbon, wherein the mean grain size of the carbon material is greater than 0.5 μm.

As an option, the mean grain size is selected from any of greater than 1 μm and greater than 2 μm.

As an option, the carbon material is in the form of a powder.

As an alternative option, the carbon material is in the form of a compact. As a further alternative option, the carbon material is in the form of a film, which may have a thickness of at least 0.01 μm and at least 0.1 μm. In these examples, the compact or the film are optionally substantially single-crystalline.

The carbon material optionally has an electrical conductivity selected from any of between 0.001 and 1000 S/m, and between 0.01 and 700 S/m.

As an option, a Fourier-transform infrared spectrum of the carbon material comprises a sharp peak at about 3300 cm⁻¹.

As an option, the carbon material is substantially free of sp²-hybridized carbon.

The carbon material is optionally alloyed with chemical elements to provide any of n-type and p-type electrical conductivity.

According to a second aspect, there is provided a method of making the carbon material described above in the first option. A substrate is located over a substrate holder within a chemical vapour deposition reactor. Process gases are fed into the reactor, the process gases comprising a carbon-containing gas and hydrogen. Carbon material as described in the first aspect is grown on a surface of the substrate using plasma assisted chemical vapour deposition under conditions suppressing the diamond growth.

As an option, the method comprises growing the carbon material at a temperature selected from any of less than 750° C., less than 700° C., less than 650° C. and less than 600° C. such that diamond deposition kinetics are limited relative to the carbon material deposition kinetics. In this case, the process gases optionally comprise at least 1.5% by volume of a carbon containing gas.

As an alternative option, the method comprises growing the carbon material at a temperature selected from any of greater than 1200° C. and greater than 1300° C. such that diamond etching kinetics are increased relative to diamond deposition kinetics.

According to a third aspect, there is provided an electronic device comprising the carbon material as described above in the first aspect.

As an option, the electronic device comprises at least two electrical contacts. As a further option, the electronic device comprises at least three electrical contacts.

As an option, the electronic device is configured in use to switch or block current.

The electronic device optionally comprises a field-effect transistor, the field-effect transistor comprising a body terminal, a source terminal and a drain terminal. The body terminal comprises doped metametallic carbon having a conductivity of either n-type or p-type, and the source terminal and the drain terminal comprise the undoped carbon material as described above in the first aspect, or alternatively other electrically conductive materials

### BRIEF DESCRIPTION OF THE DRAWINGS

The invention will now be more particularly described, by way of example only, with reference to the accompanying drawings, in which:

FIG. 1 is a high-resolution scanning electron microscopy (HRSEM) image of a metametallic carbon film described in the first example;

FIG. 2 is a micrograph showing the appearance of a focused ion beam (FIB) lamella milled from the metametallic carbon film described in the first example;

FIG. 3 is an electron diffraction pattern from the FIB lamella of the metametallic carbon film described in the first example;

FIG. 4 is an electron diffraction pattern from chips obtained as a result of scratching the metametallic carbon film with a diamond needle described in the first example;

FIG. 5 is an energy-dispersive X-ray (EDX) spectrum from the FIB lamella milled from the metametallic carbon film described in the first example;

FIG. 6a is a high-resolution transmission electron microscopy (HRTEM) image of a small area of the FIB lamella milled from the metametallic carbon film indicating the projection of the metametallic carbon crystal lattice on the (110) plane; and FIG. 6b is schematic drawing indicating a corresponding projection of the crystal lattice of the metametallic carbon according to the results of electron diffraction;

FIG. 7 is a Raman spectrum from the metametallic carbon film deposited on the diamond single-crystalline substrate described in the first example;

FIG. 8 is a Fourier transform infra-red (FTIR) spectrum from the metametallic carbon film deposited on the diamond single-crystalline substrate described in the first example;

FIG. 9 shows HRSEM images of the metametallic carbon film according to the second example;

FIG. 10 is an EDX spectrum from the metametallic carbon film obtained according to the second example;

FIG. 11 is a micrograph showing particles removed from the metametallic carbon film for their examination by selected area electron diffraction (SAED) and HRTEM;

FIG. 12 is an electron diffraction pattern from the particles removed from the metametallic carbon film obtained according to the second example. The reflections forbidden for the diamond crystal lattice are marked by *;

FIG. 13 is an HRTEM image of one particle removed from the metametallic carbon film indicating the projection of the metametallic carbon lattice on the (100) plane (above); and a schematic drawing indicating the corresponding projection of the crystal lattice of the metametallic carbon having a face-centered cubic crystal lattice according to the results of electron diffraction (below);

FIG. 14 shows a HRSEM of the film obtained according to the third example;

FIG. 15 shows a HRTEM image from the film obtained according to the third example;

FIG. 16 shows the temperature dependence of the conductivity of the film obtained according to the third example;

FIG. 17 shows an x-ray photon spectroscopy (XPS) spectrum from the film obtained according to the third example;

FIG. 18 shows an ultraviolet photon spectroscopy (UPS) spectrum from the film obtained according to the third example;

FIG. 19 shows a vacuum UV (VUV) reflectivity spectrum from the film obtained according to the third example;

FIG. 20 is flow diagram illustrating exemplary steps to make a metametallic carbon film; and

FIG. 21 illustrates schematically in a block diagram an exemplary electronic device.

### DETAILED DESCRIPTION

### Example 1

A metametallic carbon film was obtained on a single crystalline diamond substrate with the aid of plasma-assisted chemical vapour deposition (PACVD) by use of the following deposition parameters: temperature—around 600° C., hydrogen content—98 vol. %, methane content—2 vol. %, pressure—250 Torr, power—nearly 2.2 kW, deposition time—20.4 hrs. The plasma had a shape of ball of roughly 5 cm in diameter.

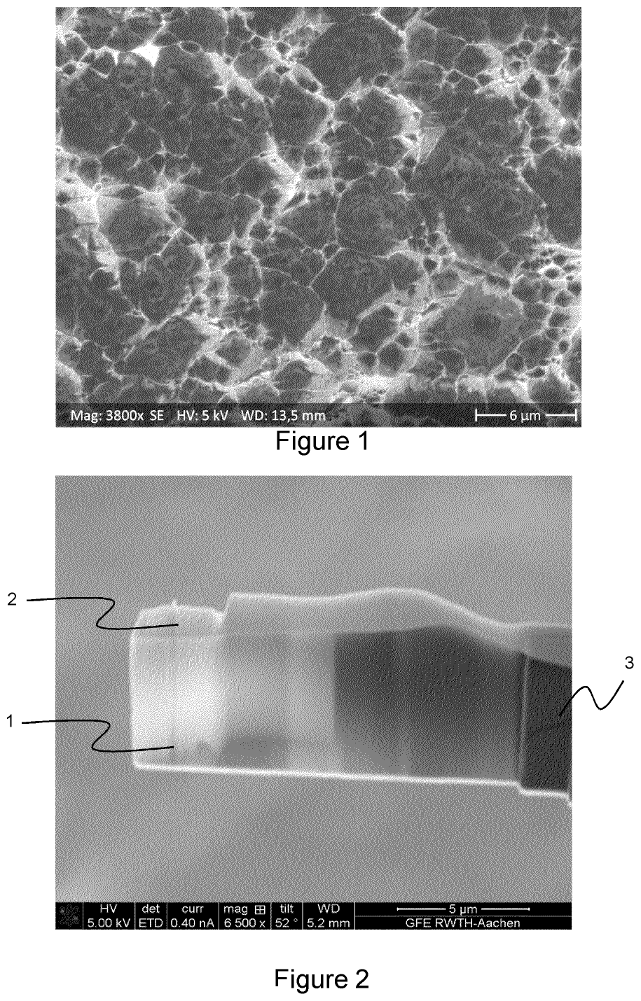

The morphology of the film shown in FIG. 1 is characterized by the presence of rounded grains having a mean grain size of about 2.5 μm.

The surface of the film was sputtered with Pt and Au in order to be able to mill a FIB lamella by use of a standard technique of ion-milling with the aid of a Ga ions' beam. The appearance of the FIB lamella is shown in FIG. 2, which shows a single crystal of metametallic carbon 1, the sputtered layer of Au and Pt 2, and a copper holder 3.

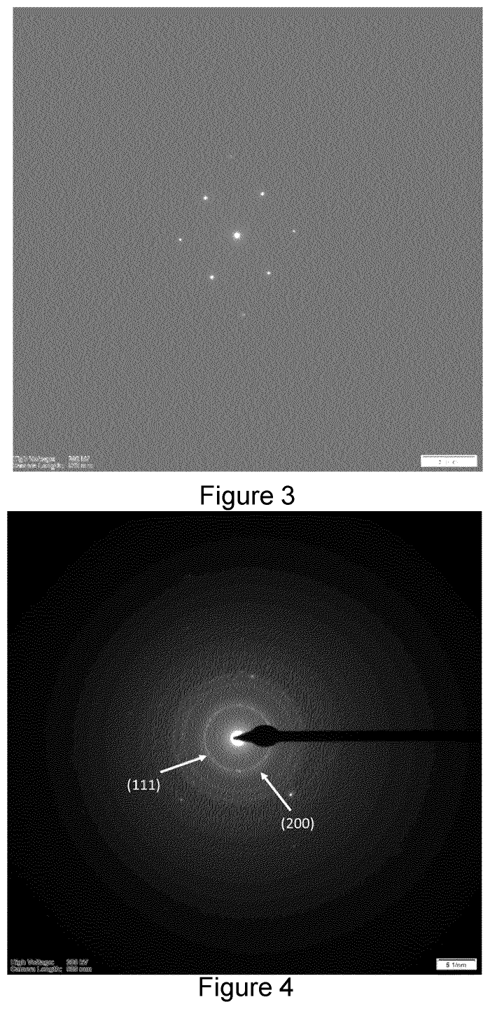

The FIB lamella was examined by use of a ChemiSTEM transmission electron microscope. FIG. 3 shows an electron diffraction pattern from the FIB lamella indicating that it consists of the carbon allotrope with the fcc crystal lattice having a crystal lattice parameter of 3.55 Å, typical for metametallic carbon. A bright field image of the FIB lamella indicated the presence of metametallic carbon. The bright field image indicated that the average thickness of the film is around 250 nm.

The film was scratched by a diamond needle to obtain a large number of tiny chips, which were afterwards collected on a Cu grid in order to obtain an electron diffraction pattern from metametallic carbon in polycrystalline form. FIG. 4 shows the resulting electron diffraction pattern, which is typical for the face-centered cubic crystal lattice of metametallic carbon comprising the (111) and (200) reflections indicated by arrows. All the reflections of the electron diffraction pattern are found to correspond to the reference values of the carbon allotrope with the face-centered cubic crystal lattice described in literature (Konyashin, et al. A New Carbon Modification: ,n-Diamond' or Face-Centered Cubic Carbon?, Diamond Relat. Mater., 10(2001) 99-10).

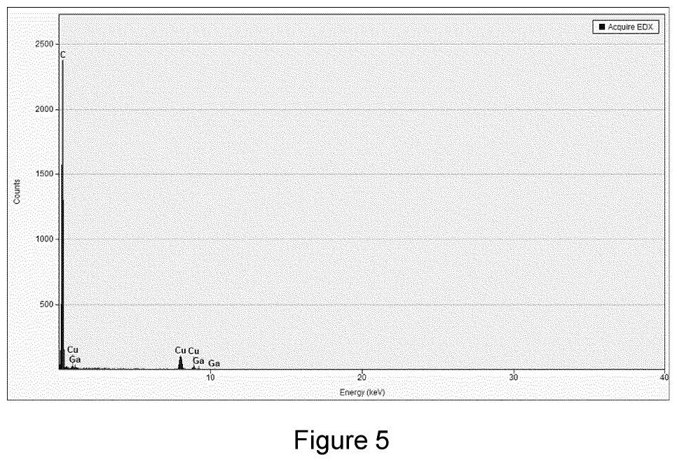

FIG. 5 shows an EDX spectrum from the film indicating that it consists of pure carbon. Very weak peaks from the Cu grid and gallium originated from the Ga ions that were employed for milling the lamella are seen in the EDX spectrum.

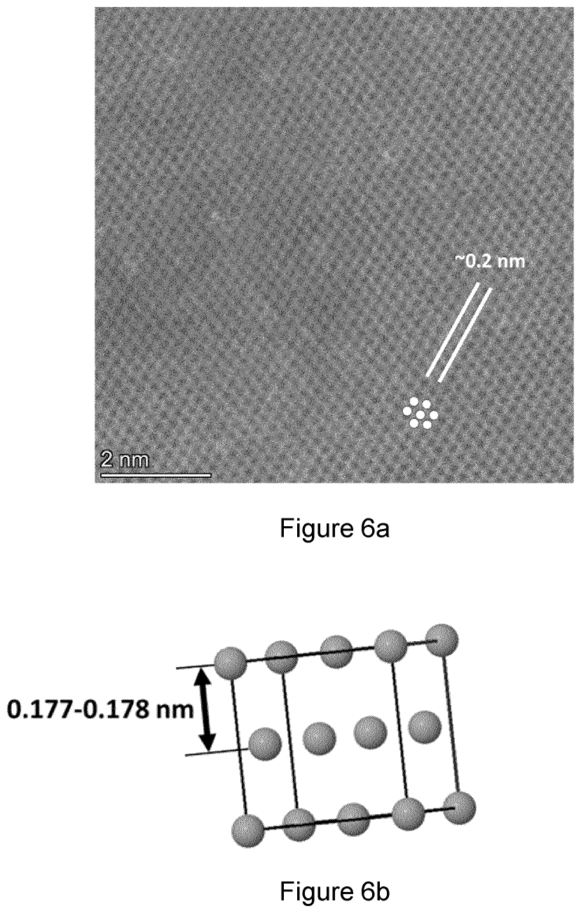

FIG. 6 shows an HRTEM image of a small area of the FIB lamella milled from the metametallic carbon film and a schematic drawing indicating the crystal lattice of the metametallic carbon has a face-centered cubic crystal lattice. One can see that metametallic carbon has a face-centered cubic crystal lattice, as the projection of the crystal lattice on the (110) plane corresponds to that of the face-centered cubic lattice. The interatomic distance between two adjacent atomic planes measured on the HRTEM image is close to the value that the metametallic carbon crystal lattice must have according to the results of electron diffraction.

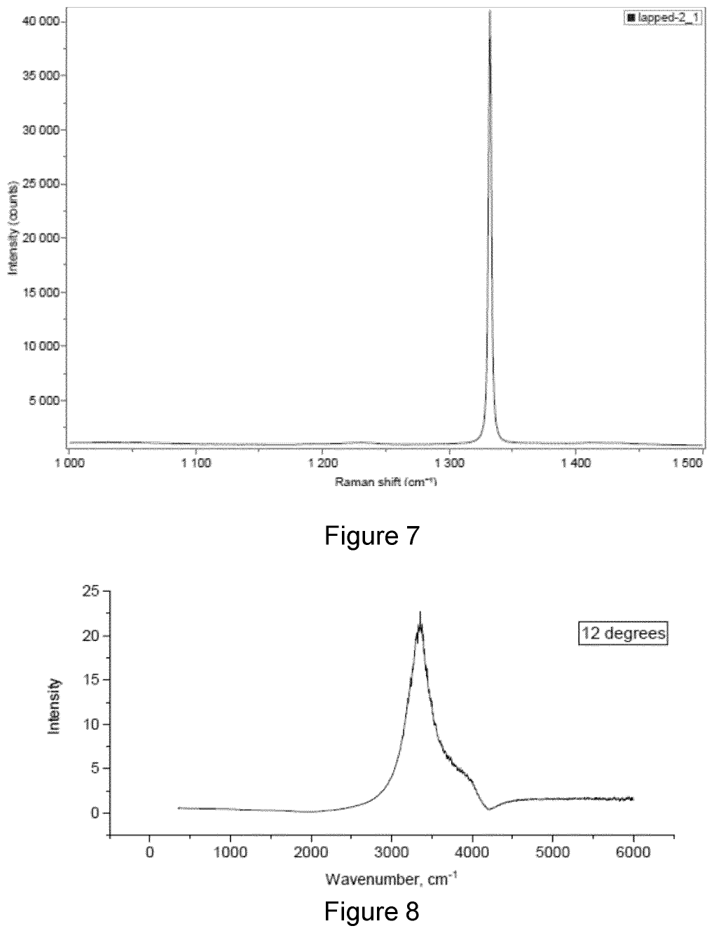

It is well known that metals with a face-centered cubic crystal lattice (the primitive unit cell of which contains only a single atom) have only acoustic phonons and no optical phonons. In Raman spectra, only optical phonons are observed; acoustic phonons have practically zero frequencies in the long-wavelength limit of the spectra, so that such metals do not show any signal in their Raman spectra. The same phenomenon occurs in the case of metametallic carbon having a face-centered cubic crystal lattice: its Raman spectrum does not comprise any peaks. Also, thin films of metametallic carbon are transparent, so that being examined by Raman spectroscopy the laser beam goes through them and interacts with a substrate material thus giving just its Raman spectrum. In case of diamond being the substrate material, the Raman spectrum from the metametallic carbon films comprises only the peak typical for diamond. FIG. 7 shows the Raman spectrum from the metametallic carbon film deposited according Example 1 on the diamond single-crystalline substrate. Only the typical sharp signal from diamond is visible in the Raman spectrum. Note that there are no signals typical for sp²-hybridized carbon in the Raman spectrum indicating that the metametallic carbon film having a mean grain size of about 2.5 μm does not comprise even traces of sp²-hybridized carbon. Note also that the Raman spectrum from the films of metametallic carbon deposited on Ni substrates according to the prior art document (Konyashin et al., A new hard allotropic form of carbon: Dream or reality? International Journal of Refractory Metals and Hard Materials, 24(2006)17-23) contains substantially no signals.

FIG. 8 shows an FTIR spectrum from the metametallic carbon film deposited on the diamond single-crystalline substrate according to Example 1. As one can see in FIG. 8, the spectrum comprises a sharp peak at about 3300 cm⁻¹, which is a special feature of metametallic carbon. Note that the peaks in the range between 1500 cm⁻¹ and 2500 cm⁻¹ typical for the chemical bonds in diamond as well as the peaks in the range between 1000 cm⁻¹ and 2200 cm⁻¹ typical for the chemical bonds in graphite are absent in the spectrum shown in FIG. 8. This provides clear evidence that the nature of chemical bonds in metametallic carbon is completely different from that in sp³-hybridized carbon and sp²-hybridized carbon.

A reason that metametallic carbon and not diamond was deposited by use of the deposition conditions employed is tentatively suggested; one can assume that the diamond etching rate by atomic hydrogen exceeded the deposition rate, which is tentatively explained by the limited presence of metastable C—H species needed for the diamond deposition in the plasma at proximity of the diamond surface, with the low temperature further limiting the deposition of said species. At these conditions, metametallic carbon appears to be a more stable carbon allotrope than diamond, due to higher growth rate, lower susceptibility to hydrogen etching or a combination of both.

### Example 2

A metametallic carbon film was obtained as a result of etching a single crystalline diamond sample (plate) in a hydrogen plasma by use of the following conditions: temperature—around 1350° C., hydrogen content—99.83 vol. %, methane content—0.17 vol. %, pressure—250 Torr, power—about 2 kW, deposition time—4 hrs. The plasma had a shape of ball of about 4 cm in diameter. A diamond sample was inserted into a graphite holder, which significantly affected the plasma distribution leading to the noticeably greater plasma density on the sample surface. As a result, the surface temperature was dramatically increased in comparison with the procedure according to Example 1.

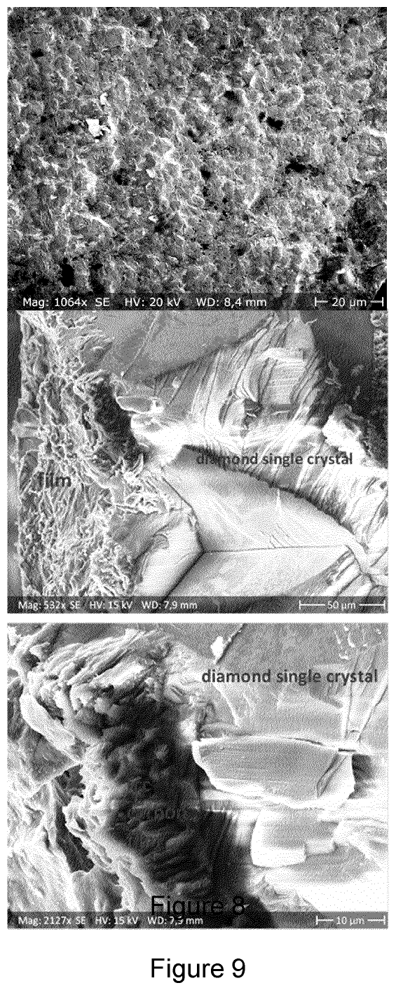

The morphology of the film shown in FIG. 9 is characterized by the presence of medium-coarse grains having a mean grain size of nearly 3 to 5 μm.

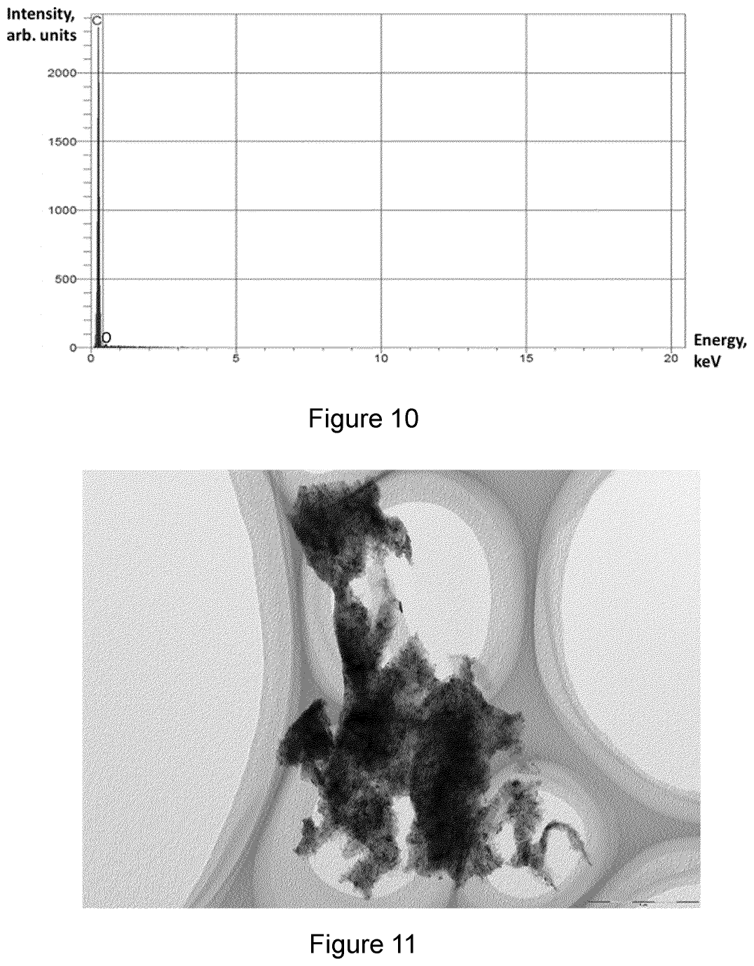

The film was examined by EDX and found to consist of pure carbon, as shown in FIG. 10.

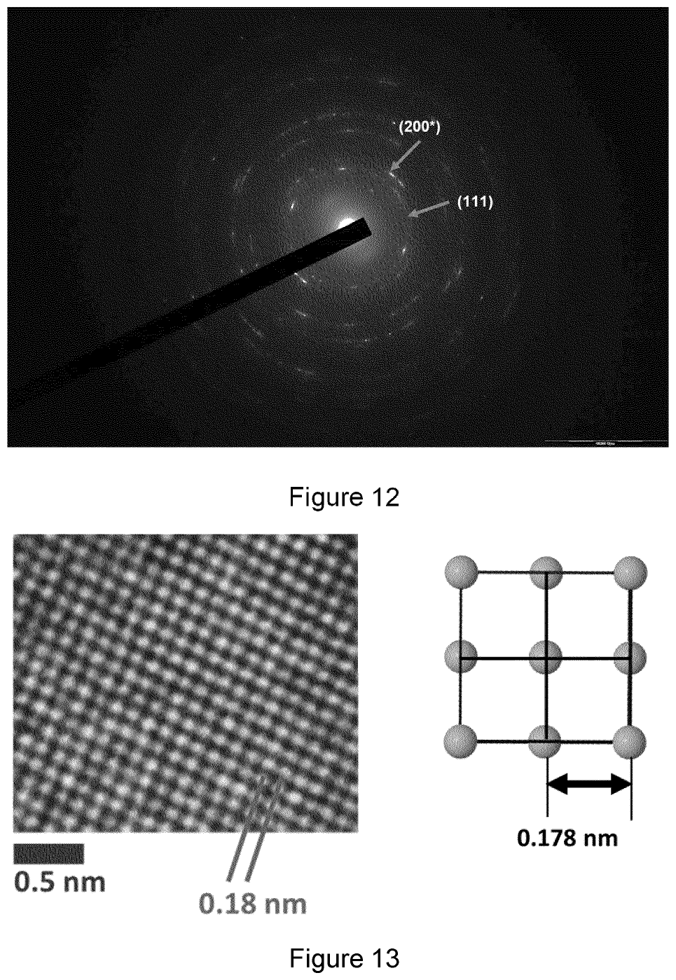

Tiny particles, some of which are shown in FIG. 11, were removed from the sample surface by very gentle scratching with the aid of a copper grid. All the particles were first analysed by EDX and found to consist of pure carbon. Several particles were examined by electron diffraction (SAED). The electron diffraction pattern from the particles is shown in FIG. 12.

FIG. 12 shows rings typical for polycrystalline materials; the (111), (200), (220), (311) and (222) reflections are indicated by arrows. The reflections forbidden for the diamond crystal lattice are marked by *. All the reflections of the pattern are found to correspond to the reference values of the carbon allotrope with the face-centered cubic crystal lattice reported in literature (Konyashin et al., A New Carbon Modification: ,n-Diamond' or Face-Centered Cubic Carbon?, Diamond Relat. Mater., 10(2001) 99-10) proving evidence that the particles consist of just metametallic carbon. All other particles removed from the film showed similar electron diffraction patterns.

FIG. 13 shows an HRTEM image of a small area of one particle removed from the metametallic carbon film and a schematic drawing indicating the crystal lattice of the metametallic carbon having a face-centered cubic crystal lattice. One can see that metametallic carbon has a face-centered cubic crystal lattice, as the projection of its crystal lattice on the (100) plane corresponds to that of the face-centered cubic crystal lattice and the interatomic distance between two adjacent atomic planes measured on the HRTEM image is very close to the value that the metametallic carbon crystal lattice must have.

Not being bound by hypotheses why the film of just metametallic carbon formed on the surface of the diamond sample by use of the experimental conditions employed, one can assume that the limited number of carbon species in the plasma containing a large excess of hydrogen combined with the very high surface temperature (about 1350° C.) largely favours the etching process over the growth process. This etching process is thought to occur through an intermediate stage of the metametallic carbon formation. As a result, the film of metametallic carbon forms on the surface of the diamond single-crystalline sample.

### Example 3

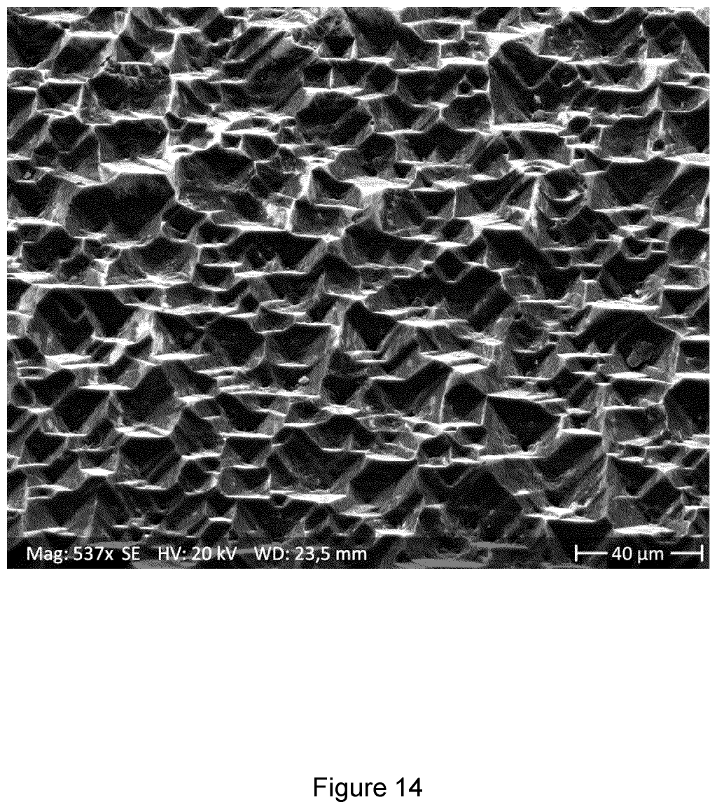

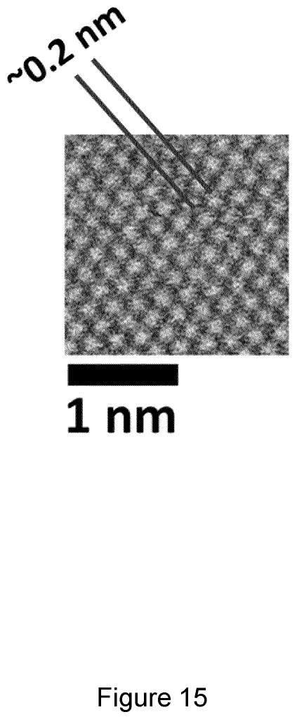

A carbon film was deposited in a similar way to that described in Example 1 except for the following: (1) the pressure was reduced to 220 Torr, (2) the deposition duration was equal to 120 hours. As a result, the average film thickness was roughly 1 μm. The morphology of the film is shown in FIG. 14. Results of XRD studies indicated that the film is single-crystalline; it was epitaxially grown on the single-crystalline diamond substrate.

Results of the XRD studies indicated that the film has a face-centered cubic crystal structure with a lattice parameter of 0.3577 nm, providing evidence that the film consists of metametallic carbon. The XRD pattern comprises the (200) and (222) peaks that are forbidden for the diamond crystal lattice.

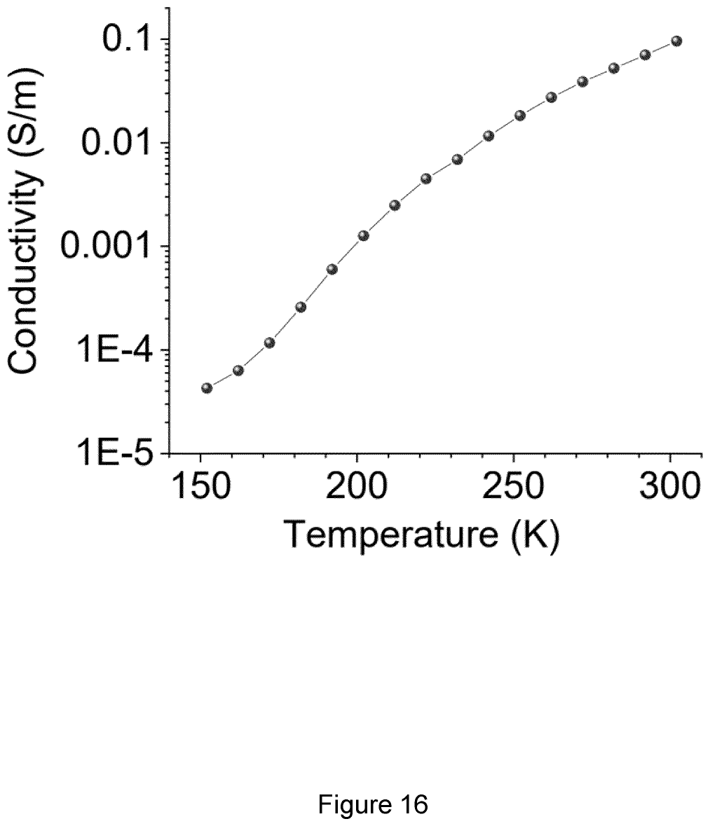

An FIB lamella was prepared from the sample and HRTEM studies were performed. FIG. 16 shows an HRTEM image from the film providing evidence that its crystal lattice corresponds to that of metametallic carbon.

2-wire measurements of electrical resistivity were conducted on the film surface at both room temperature and cryogenic temperatures by use of indium contacts adjusted to the film surface. The sample temperature was swept from 302 K to 2 K and back in 31 steps in each direction. As the temperature decreases, the electrical resistance increases from 6.7 MΩ at 302 K up to 19 GΩ at 142 K. The resistance level went above the equipment's top measurement limit of ˜20 GΩ for the lower temperatures; values of the film's electrical conductivity were calculated on the basis of the resistance values. FIG. 16 shows the temperature dependence of electrical conductivity. As can be seen in FIG. 16, the electrical resistance at room temperature is about 0.1 S/m and it decreases when decreasing the temperature. The conductivity value at room temperature and its temperature dependence provide clear evidence that metametallic carbon is an intrinsic semiconductor.

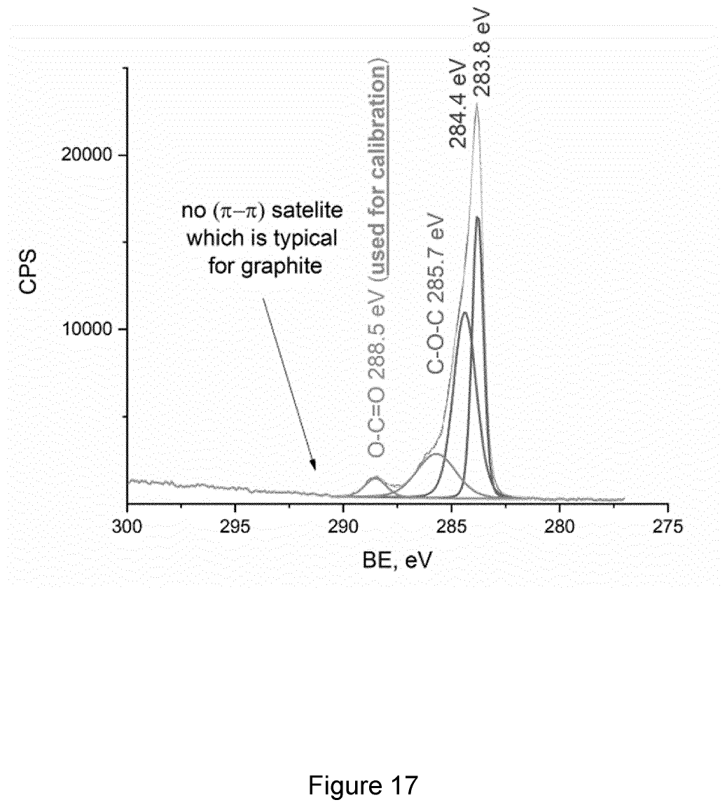

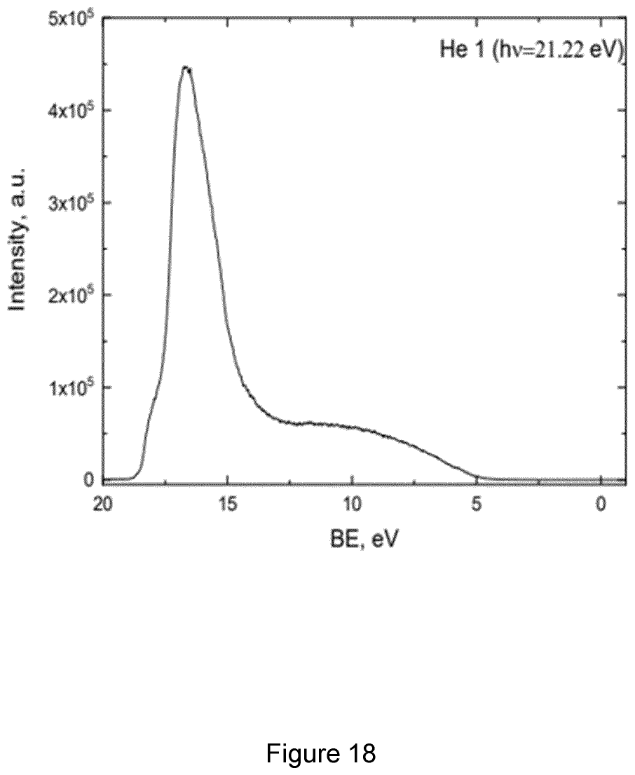

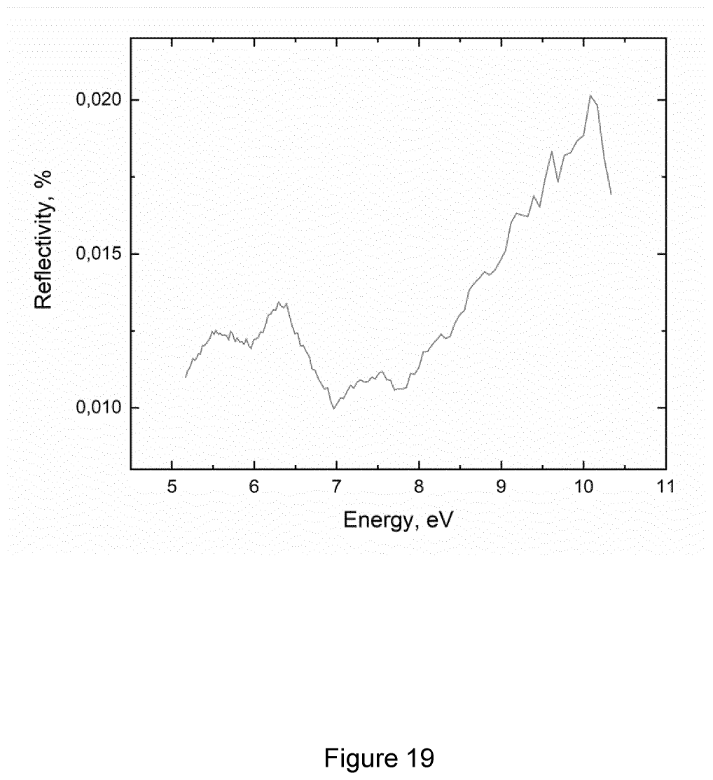

FIG. 17 shows the results of XPS of the film, FIG. 18 shows results of UPS of the film and FIG. 19 shows a vacuum UV (VUV) reflectivity spectrum from the film.

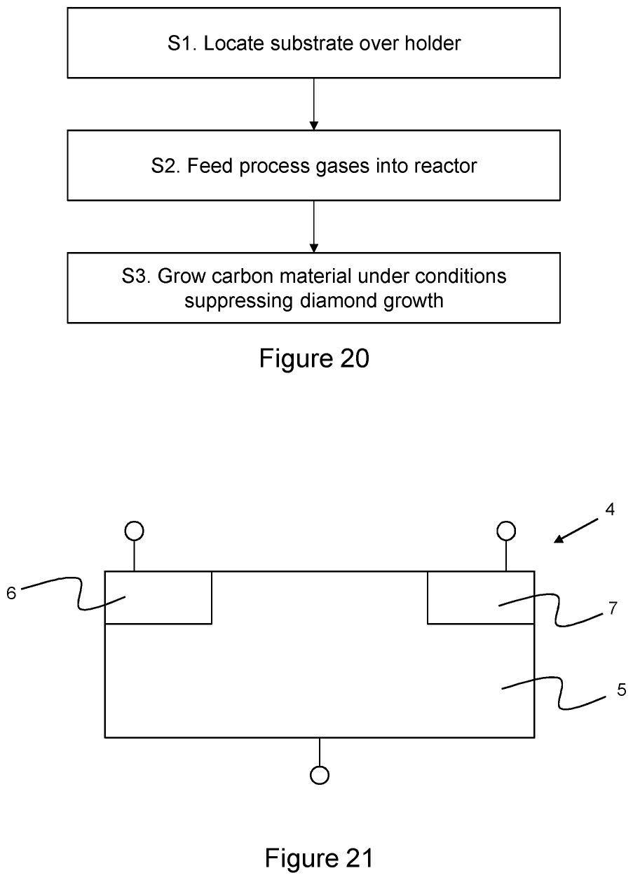

FIG. 20 is a flow diagram showing exemplary steps to grow the carbon material described above. The following numbering corresponds to that of FIG. 20:
S1. A substrate is located over a substrate holder within a chemical vapour deposition reactor.
S2. Process gases are fed into the reactor. The process gases include a carbon-containing gas and hydrogen.
S3. Carbon material is grown on a surface of the substrate using plasma assisted chemical vapour deposition under conditions suppressing the diamond growth. These conditions may include, for example, low temperature (e.g. less than 750° C., less than 700° C., less than 650° C. and less than 600° C.) in order to limit diamond deposition kinetics and increase the carbon material deposition kinetics. Alternatively, the conditions may include growing the carbon material at a temperature selected from any of greater than 1200° C., greater than 1250° C., greater than 1300° C. and greater than 1350° C., in order to increase diamond etching kinetics relative to diamond deposition kinetics.

FIG. 21 illustrates schematically in a block diagram an exemplary electronic device 4. In this example. the electronic device 4 is a field-effect transistor. The field-effect transistor has a body terminal 5, a source terminal 6 and a drain terminal 7. The terminals each have associated electrical contacts. The body terminal 5 comprises doped metametallic carbon having a conductivity of either n-type or p-type, and the source terminal 6 and the drain terminal 7 comprise the metametallic carbon material described above. It will be appreciated that the metametallic carbon material may be used in other types of electronic device.

The invention as set out in the appended claims has been shown and described with reference to embodiments. However, it will be understood by those skilled in the art that various changes in form and detail may be made without departing from the scope of the invention as defined by the appended claims, and while exemplary techniques have been described, it may be that other techniques may be used to obtain the metametallic carbon material described in the appended claims.

1. A carbon material having a face-centered cubic crystal lattice characterized by a space group Fm-3m and containing at least 99.9 atomic % carbon, wherein a mean grain size of the carbon material is greater than 0.5 μm.

2. The carbon material according to claim 1, wherein the mean grain size is selected from any of greater than 1 μm and greater than 2 μm.

3. The carbon material according to claim 1, wherein the carbon material is in the form of a powder.

4. The carbon material according to claim 1, wherein the carbon material is in the form selected from any of a compact and a film.

5. (canceled)

6. The carbon material according to claim 4, wherein the compact or film is substantially single-crystalline.

7. (canceled)

8. The carbon material according to claim 1, wherein the carbon material has an electrical conductivity selected from any of between 0.001 and 1000 S/m, and between 0.01 and 700 S/m.

9. The carbon material according to according to claim 1, wherein a Fourier-transform infrared spectrum of the carbon material comprises a sharp peak at about 3300 cm⁻¹.

10. The carbon material according to according to claim 1, wherein the carbon material is substantially free of sp2-hybridized carbon.

11. The carbon material according to according to claim 1, wherein the carbon material is alloyed with chemical elements to provide any of n-type and p-type electrical conductivity.

12. A method of making the carbon material according to claim 1, the method comprising:
locating a substrate over a substrate holder within a chemical vapour deposition reactor;
feeding process gases into the reactor, the process gases comprising a carbon-containing gas and hydrogen;
growing the carbon material according to claim 1 on a surface of the substrate using plasma assisted chemical vapour deposition under conditions suppressing diamond growth.

13. The method according to claim 12, comprising growing the carbon material at a temperature selected from any of less than 750° C., less than 700° C., less than 650° C. and less than 600° C. such that diamond deposition kinetics are limited relative to carbon material deposition kinetics.

14. The method according to claim 13, wherein the process gases comprise at least 1.5% by volume of a carbon containing gas.

15. The method according to claim 12, comprising growing the carbon material at a temperature selected from any of greater than 1200° C. and greater than 1300° C. such that diamond etching kinetics are increased relative to diamond deposition kinetics.

16. An electronic device comprising the carbon material according to claim 1.

17. The electronic device according to claim 16, comprising at least two electrical contacts.

18. The electronic device according to claim 16, comprising at least three electrical contacts.

19. The electronic device according to claim 16, wherein the electronic device is configured in use to switch or block current.

20. The electronic device according to claim 16, wherein the electronic device comprises a field-effect transistor, the field-effect transistor comprising:
a body terminal;
a source terminal; and
a drain terminal;
wherein the body terminal comprises doped diamond having a conductivity of either n-type or p-type, and the source terminal and the drain terminal comprise the carbon material.
